(19) United States
(12) Patent Application Publication
(10) Pub. No.: US 2023/0233056 A1
(43) Pub. Date: Jul. 27, 2023

(54) SHOE DRYER

(71) Applicant: Chengchuan Lin, Xiamen (CN)

(72) Inventor: Chengchuan Lin, Xiamen (CN)

(21) Appl. No.: 18/079,889

(22) Filed: Dec. 13, 2022

(30) Foreign Application Priority Data
Jan. 25, 2022 (CN) 202220205453.8

(51) Int. Cl. A47L 23/20

(52) U.S. Cl. CPC A47L 23/205

(57) ABSTRACT

A shoe dryer includes a base, a heat supply tube, an object support, and a heating device. The base includes a first base and a second base that are detachably connected. The first base and the second base have at least one pair of a first connecting portion and a second connecting portion that are male and female connecting portions and connected in a snap-fit manner, so that the first base and the second base form the whole base. A lower end of the heat supply tube is mounted to the first base. The object support is mounted to an upper end of the heat supply tube. The heating device is configured to supply hot air to the heat supply tube.

### BACKGROUND OF THE INVENTION

### 1. Field of the Invention The present invention relates to a shoe dryer, and more particularly to a novel shoe dryer.

### 2. Description of the Prior Art

A shoe dryer, also known as shoe-drying device and shoe warmer, is a small household appliance designed for drying shoes. The shoe dryer has the functions of drying, sterilization, deodorization, etc., so it can solve some foot problems and diseases for people, such as cold feet, athlete's foot, frostbite and so on. With the changes of the times, shoe dryers have been developed to become a product having different functions and appearances.

There is an adjustable shoe dryer is on the market. The adjustable shoe dryer includes a heat supply tube. The heat supply tube is composed of an inner tube and an outer tube that is movably sleeved on the inner tube. The length of the heat supply tube can be adjusted, so that the shoe dryer can be adapted to shoes of different sizes and shapes. In order to adapt to the adjustable heat supply tube, the base of the shoe dryer is designed to be relatively large for supporting large and heavy shoes. Thus, the whole shoe dryer is relatively large. It takes up a lot of space for packaging and storage, causing inconvenience to manufacturers and users. Besides, it is not easy to remove the base of the shoe dryer.

### SUMMARY OF THE INVENTION

In order to solve the above-mentioned problems in the prior art, the primary object of the present invention is to provide a shoe dryer.

In order to achieve the foregoing object, the technical solutions of the present invention are described below.

A shoe dryer comprises a base, a heat supply tube, an object support, and a heating device. The base includes a first base and a second base that are detachably connected. The first base has a first connecting face. The second base has a second connecting face. The first connecting face is matched with the second connecting face. The first connecting face and the second connecting face have at least one pair of a first connecting portion and a second connecting portion that are male and female connecting portions and connected in a snap-fit manner. When the first connecting portion and the second connecting portion are assembled, the first connecting face is attached to the second connecting face so that the first base and the second base form the whole base. A lower end of the heat supply tube is mounted to an upper surface of the first base. The object support is mounted to an upper end of the heat supply tube. The heating device is configured to supply hot air to the heat supply tube.

The first connecting portion is a special-shaped hole disposed on the first connecting face. The second connecting portion is a special-shaped protruding block disposed on the second connecting face. The special-shaped protruding block is composed of a connecting post and a restricting plate. Two ends of the connecting post are vertically connected to the second connecting face and the restricting plate, respectively. The special-shaped hole is composed of a receiving hole and a restricting hole. The restricting plate is inserted through the receiving hole and restricted by the restricting hole. The restricting hole is above the receiving hole.

The at least one pair of the first and second connecting portions includes three pairs of the first and second connecting portions.

The three pairs of the first and second connecting portions of the first base and the second base are located at a centerline of the first connecting face and the second connecting face and two sides of the centerline, respectively.

Restricting protrusions are disposed on two sides of an upper end of the connecting post. Two side walls of the restricting hole have protruding portions for restricting the restricting protrusions and positioning holes for matching with the restricting protrusions. A distance between the protruding portions is less than a lateral width of the two restricting protrusions.

The heat supply tube includes an inner tube and an outer tube that is movably sleeved on the inner tube.

A lower end of the inner tube is fixedly connected to the upper surface of the first base. An upper end of the outer tube is connected to the object support. A plurality of vents is disposed on a side wall and a top of the outer tube.

The object support is a plurality of spaced support sheets connected to the upper end of the heat supply tube.

The support plates each have an L shape.

The heating device is disposed in the first base or the heat supply tube.

Through the above solutions, in the present invention, the base is divided into the first base and the second base. The first base and the second base have the first connecting portion and the second connecting portion that are male and female connecting portions and connected in a snap-fit manner, so that the user can freely choose whether to use the second base or not. When the second base is used and connected to the first base, the ground contact area of the base is increased to improve the support capacity, so that the shoe dryer will not fall over because of heavy shoes hanging on the object support. When the second base is not used, the ground contact area of the base is reduced. The overall structure of the shoe dryer occupies less space, so it can be stored and packed easily.

### BRIEF DESCRIPTION OF THE DRAWINGS

FIG. 1 is a first perspective view according to a preferred embodiment of the present invention;

FIG. 2 is a second perspective view according to the preferred embodiment of the present invention;

FIG. 3 is a first exploded view according to the preferred embodiment of the present invention;

FIG. 4 is a second exploded view according to the preferred embodiment of the present invention;

FIG. 5 is a cross-sectional view according to the preferred embodiment of the present invention; and

FIG. 6 is an enlarged view of circle A of FIG. 5.

### DETAILED DESCRIPTION OF THE PREFERRED EMBODIMENTS

Embodiments of the present invention will now be described, by way of example only, with reference to the accompanying drawings.

The present invention discloses a shoe dryer, comprising a base 1, a heat supply tube 2, an object support 3, and a heating device 4.

The base 1 includes a first base 11 and a second base 12 that are detachably connected. The first base 11 has a first connecting face 111. The second base 12 has a second connecting face 121. The first connecting face 111 is matched with the second connecting face 121. The first connecting face 111 and the second connecting face 121 have at least one pair of a first connecting portion 112 and a second connecting portion 122 that are male and female connecting portions and connected in a snap-fit manner. When the first connecting portion 112 and the second connecting portion 122 are assembled, the first connecting face 111 is attached to the second connecting face 121, so that the first base 11 and the second base 12 form the whole base 1. The first base 11 and the second base 12 are relatively restricted in the lateral direction.

The lower end of the heat supply tube 2 is mounted to the upper surface of the first base 11. The object support 3 is mounted to the upper end of the heat supply tube 2.

The heating device 4 is configured to supply hot air to the heat supply tube 2.

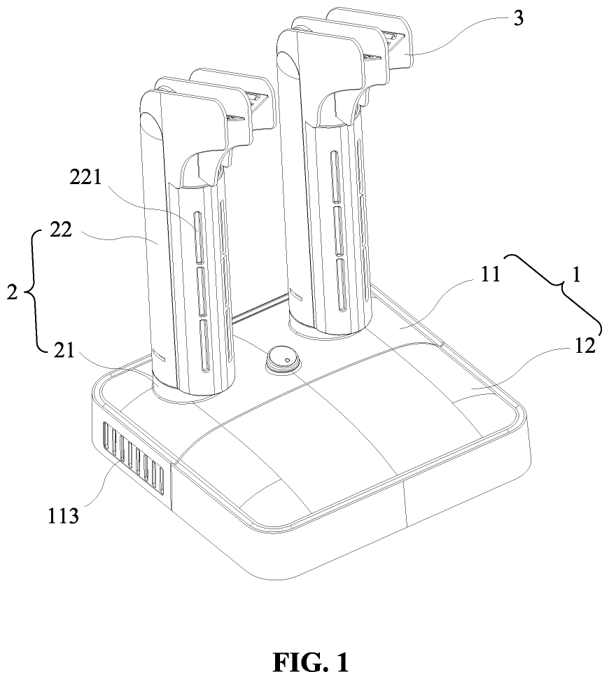

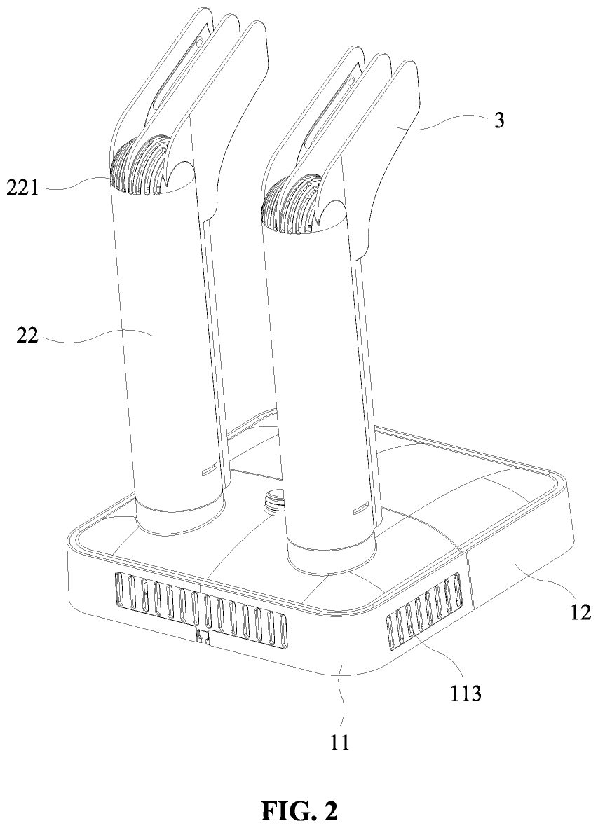

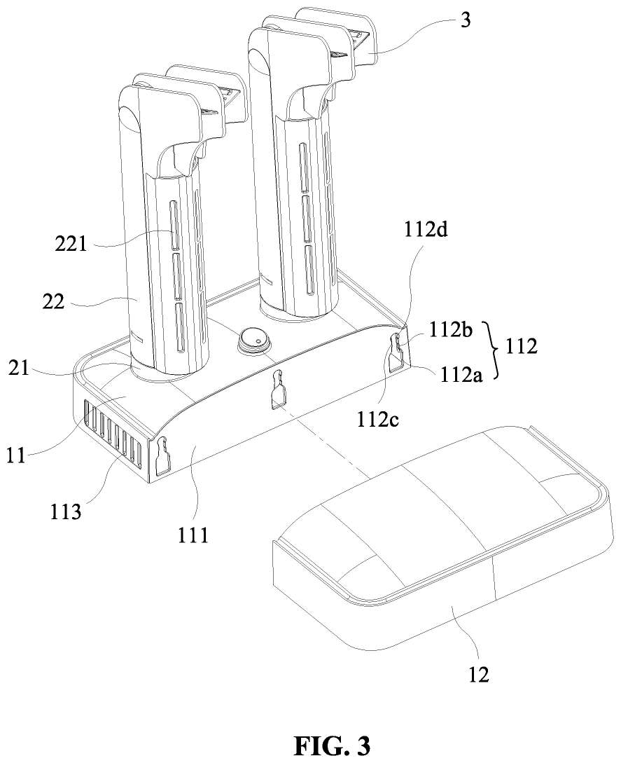

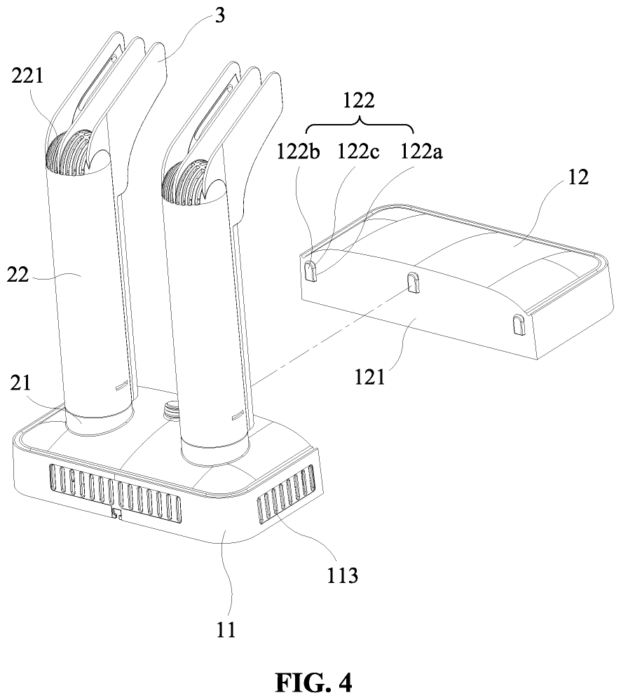

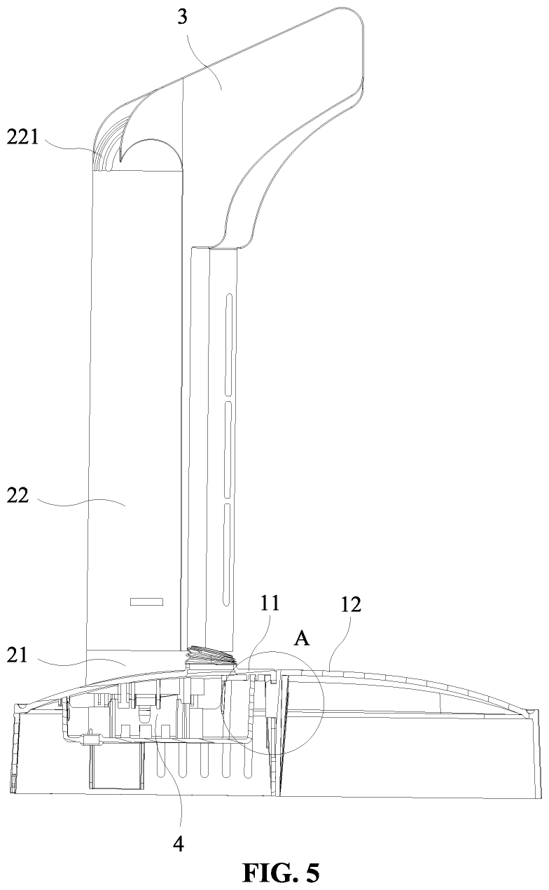

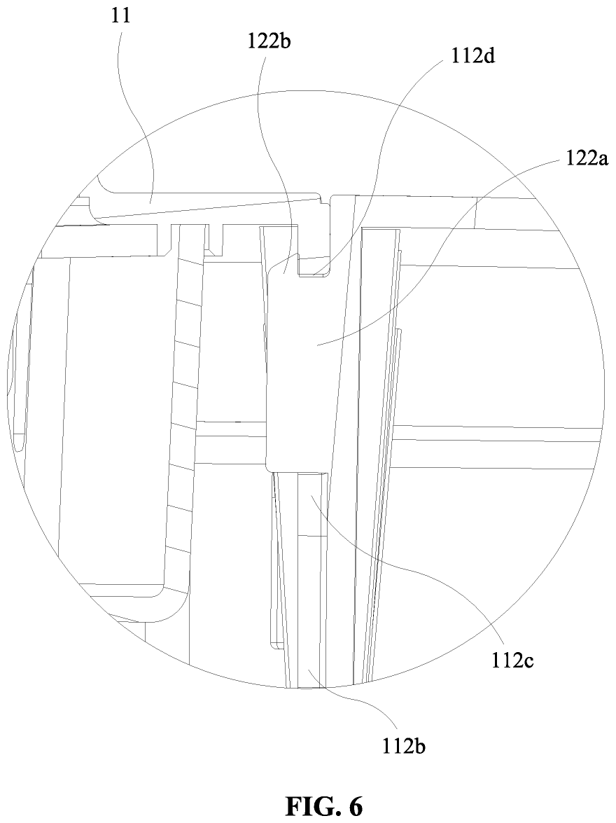

FIGS. 1 to 6 illustrate a preferred embodiment of the present invention.

The first connecting portion 112 is a special-shaped hole disposed on the first connecting face 111. The second connecting portion 122 is a special-shaped protruding block disposed on the second connecting face 121. The special-shaped protruding block is composed of a connecting post 122a and a restricting plate 122b. Two ends of the connecting post 122a are vertically connected to the second connecting face 121 and the restricting plate 122b, respectively. The special-shaped hole is composed of a receiving hole 112a and a restricting hole 112b. The restricting plate 122b is inserted through the receiving hole 112a and restricted by the restricting hole 112b. The restricting hole 112b is above the receiving hole 112a. When assembled, the restricting plate 122b is inserted in the special-shaped hole from the receiving hole 112a and moved toward the restricting hole 112b, so that the connecting post 122a is engaged in the restricting hole 112b. The mutual restriction of the restricting plate 122b and the restricting hole 112b realizes the relative restriction of the first base 11 and the second base 12 in the lateral direction. In addition, the first connecting portion 112 and the second connecting portion 122 may be detachable connecting and matching structures in the form of a convex post and a concave hole, or may be connected in a snap-fit manner, and the like.

Furthermore, the at least one pair of the first and second connecting portions 112, 122 includes three pairs of the first and second connecting portions 112, 122. The more the first connecting portions 112 and the second connecting portions 122 are provided, the more reliable the first base 11 and the second base 12 are assembled. In this embodiment, the three pairs of the first and second connecting portions 112, 122 are located at the centerline of the first connecting face 111 and the second connecting face 121 and two sides of the centerline, respectively. The pair of the first and second connecting portions 112,122 at the centerline is higher/lower the other two pairs of the first and second connecting portions 112, 122, so that the three pairs of the first and second connecting portions 112,122 are in a triangular configuration. The first base 11 and the second base 12 are assembled stably. In addition, the length of the first connecting portion 112/the second connecting portion 122 at the centerline may be extended in the longitudinal direction. When the connecting post 122a and the restricting plate 122b are engaged with the restricting hole 112b, the friction surface is longer. It is not easy to cause the first base 11 and the second base 12 to fall off longitudinally.

Restricting protrusions 122c are disposed on two sides of the upper end of the connecting post 122a Two side walls of the restricting hole 112b have protruding portions 112c for restricting the restricting protrusions 122c and positioning holes 112d for matching with the restricting protrusions 122c. The distance between the protruding portions 112c is less than the lateral width of the two restricting protrusions 122c, so that after the first connecting portion 112 and the second connecting portion 122 are assembled, the connecting post 122a is tightly fitted with the restricting hole 112b to reduce shaking. The restricting protrusions 122c are just engaged in the positioning holes 112d to prevent the first base 11 and the second base 12 from sliding up and down and falling off. The distance between the inner side of the restricting plate 122b and the second connecting face 121 just fits tightly with the wall thickness of the first connecting face 111. The inner side of the restricting plate 122b is in close contact with the inner side of the first connecting portion 112 of the first connecting face 111 other than the receiving hole 112a to increase friction and prevent the first and second bases from sliding longitudinally and falling off because the second base 12 may be too heavy and slide down to disengage from the first base 11.

The heat supply tube 2 includes an inner tube 21 and an outer tube 22 that is movably sleeved on the inner tube 21. The length of the heat supply tube 2 can be adjusted according to the needs of the user, so the use is more flexible. In this embodiment, the lower end of the inner tube 21 is fixedly connected to the upper surface of the first base 11. The upper end of the outer tube 22 is connected to the object support 3. A plurality of vents 221 is disposed on the side wall and the top of the outer tube 22. The vents 221 may be elongate holes arranged in the axial direction of the outer tube 22 to increase the area of the vents 221 on the outer tube 22 and improve the heat supply effect. In addition, in order to meet the needs of adjustment and positioning, a movable positioning structure may be disposed between the inner tube 21 and the outer tube 22, such as the cooperation between a spherical protrusion and a restricting groove. A tight fit between the inner tube 21 and the outer tube 22 may achieve movable positioning.

The object support 3 is a plurality of spaced support sheets connected to the upper end of the heat supply tube 2. When the object support 3 supports the shoe, only the upper edge of the support sheet is in contact with the shoe to minimize the contact area That is, the contact area between the hot air and the shoe is maximized, and the drying effect is better.

Furthermore, the support plate is L-shaped to match the shape of the inner cavity of the shoe, providing a more stable support effect.

A plurality of heat dissipation holes 113 is disposed on the side wall of the first base 11 to realize heat dissipation of the base 1.

In general, as shown in the drawings of this embodiment, two sets of heat supply tubes 2 and object supports 3 are symmetrically arranged on the base 1, so that the shoe dryer can dry the left and right shoes of the same pair of shoes at the same time, thereby improving the drying efficiency.

According to actual product requirements, the heating device 4 may be disposed in the first base 11 or the heat supply tube 2 (the inner tube 21).

In addition, the first connecting portion 112 and the second connecting portion 122 may be two magnets that are magnetically engaged with each other.

Through the above solutions, in the present invention, the base 1 includes the first base 11 and the second base 12. The first base 11 and the second base 12 have the first connecting portion 112 and the second connecting portion 122 that are male and female connecting portions and connected in a snap-fit manner, so that the user can freely choose whether to use the second base 12 or not. When the second base 12 is used and connected to the first base 11, the ground contact area of the base 1 is increased to improve the support capacity, so that the shoe dryer will not fall over because of heavy shoes hanging on the object support 3. When the second base 12 is not used, the ground contact area of the base 1 is reduced. The overall structure of the shoe dryer occupies less space, so it can be stored and packed easily.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A shoe dryer, comprising a base, a heat supply tube, an object support, and a heating device;
the base including a first base and a second base that are detachably connected; the first base having a first connecting face, the second base having a second connecting face, the first connecting face being matched with the second connecting face, the first connecting face and the second connecting face having at least one pair of a first connecting portion and a second connecting portion that are male and female connecting portions and connected in a snap-fit manner, wherein when the first connecting portion and the second connecting portion are assembled, the first connecting face is attached to the second connecting face so that the first base and the second base form the whole base;
a lower end of the heat supply tube being mounted to an upper surface of the first base;
the object support being mounted to an upper end of the heat supply tube;
the heating device being configured to supply hot air to the heat supply tube.

2. The shoe dryer as claimed in claim 1, wherein the first connecting portion is a special-shaped hole disposed on the first connecting face, the second connecting portion is a special-shaped protruding block disposed on the second connecting face;
the special-shaped protruding block is composed of a connecting post and a restricting plate, two ends of the connecting post are vertically connected to the second connecting face and the restricting plate, respectively;
the special-shaped hole is composed of a receiving hole and a restricting hole, the restricting plate is inserted through the receiving hole and restricted by the restricting hole, and the restricting hole is above the receiving hole.

3. The shoe dryer as claimed in claim 2, wherein the at least one pair of the first and second connecting portions includes three pairs of the first and second connecting portions.

4. The shoe dryer as claimed in claim 3, wherein the three pairs of the first and second connecting portions of the first base and the second base are located at a centerline of the first connecting face and the second connecting face and two sides of the centerline, respectively.

5. The shoe dryer as claimed in claim 3, wherein restricting protrusions are disposed on two sides of an upper end of the connecting post;
two side walls of the restricting hole have protruding portions for restricting the restricting protrusions and positioning holes for matching with the restricting protrusions, and a distance between the protruding portions is less than a lateral width of the two restricting protrusions.

6. The shoe dryer as claimed in claim 1, wherein the heat supply tube includes an inner tube and an outer tube that is movably sleeved on the inner tube.

7. The shoe dryer as claimed in claim 6, wherein a lower end of the inner tube is fixedly connected to the upper surface of the first base;
an upper end of the outer tube is connected to the object support, and a plurality of vents is disposed on a side wall and a top of the outer tube.

8. The shoe dryer as claimed in claim 1, wherein the object support is a plurality of spaced support sheets connected to the upper end of the heat supply tube.

9. The shoe dryer as claimed in claim 8, wherein the support plates each have an L shape.

10. The shoe dryer as claimed in claim 1, wherein the heating device is disposed in one of the first base and the heat supply tube.
